(19) United States
(12) Patent Application Publication
(10) Pub. No.: US 2013/0346532 A1
(43) Pub. Date: Dec. 26, 2013

(54) VIRTUAL SHARED STORAGE IN A CLUSTER

(71) Applicants: Andrea D'Amato, Kirkland, WA (US); Vinod R. Shankar, Woodinville, WA (US)

(72) Inventors: Andrea D'Amato, Kirkland, WA (US); Vinod R. Shankar, Woodinville, WA (US)

(73) Assignee: MICROSOFT CORPORATION, Redmond, WA (US)

(21) Appl. No.: 13/529,872

(22) Filed: Jun. 21, 2012

(51) Int. Cl. G06F 15/167

(52) U.S. Cl. 709/213

(57) ABSTRACT

The present invention minimizes the cost of establishing a cluster that utilizes shared storage by creating a storage namespace within the cluster that makes each storage device, which is physically connected to any of the nodes in the cluster, appear to be physically connected to all nodes in the cluster. A virtual host bus adapter (VHBA) is executed on each node, and is used to create the storage namespace. Each VHBA determines which storage devices are physically connected to the node on which the VHBA executes, as well as each storage device that is physically connected to each of the other nodes. All storage devices determined in this manner are aggregated into the storage namespace which is then presented to the operating system on each node so as to provide the illusion that all storage devices in the storage namespace are physically connected to each node.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

Clustering is the technique of interconnecting multiple computers (e.g. servers) in a way that allows them to work together such as to provide highly available applications by implementing failover when a node of the cluster goes down. To implement clustering, shared storage is required. For example, to enable failover of an application from a first node to a second node in the cluster, a shared storage is required so that the application can continue to access the same data in the shared storage whether the application is executing on the first or the second node. Applications that implement failover are referred to as being highly available.

FIG. 1 depicts a typical prior art cluster architecture 100 that includes three server nodes 101-103 and shared storage 104. Each of nodes 101-103 is physically connected to shared storage 104 to enable applications executing on each node to access data stored on shared storage 104. Each of nodes 101-103 is also shown as including local storage devices 110-111, 112-113, and 114-115 respectively. Local storage devices 110-115 represent the hard drive, sold state drive, or other local storage device that is typically included in a server. In other words, each of servers 101-103 can represent a server that is purchased from a third party vendor such as IBM, Dell, or HP.

In FIG. 1, shared storage 104 represents a box containing storage hardware such as drives as well as networking components for enabling the storage hardware to be accessed as shared storage (e.g. as a storage area network (SAN)). Such components can include, for example, a host adapter, fibre channel switches, etc. Storage array 104 can be a storage solution provided by a third party vendor such as an EMC storage solution.

Storage array 104 generally is an expensive component of a cluster (e.g. exceeding millions of dollars in some clusters). Further, storage array 104 is not the only significant expense when establishing a cluster. For each node to communicate with storage array 104, each node will require appropriate storage components such as a host bus adapter (HBA). For example, if fibre channel is used to connect each node to storage array 104, each node will require a fibre channel adapter (represented as components 101a-103a in FIG. 1). A fibre channel switch will also be required to connect each node to storage array 104. These additional components add to the expense of establishing a cluster.

As shown, the typical cluster architecture requires each node to be directly connected to storage array 104. Accordingly, to establish a cluster, a business typically purchases multiple servers, an operating system for each server, a shared storage solution (storage array 104), and other necessary components such as those for interconnecting the servers with the shared storage (e.g. components 101a-103a, 105, etc.).

### BRIEF SUMMARY

The present invention extends to methods, systems, and computer program products for minimizing the cost of establishing a cluster of nodes that utilize shared storage. The invention enables storage devices that are physically connected to a subset of the nodes in the cluster to be accessed as shared storage from any node in the cluster.

The invention provides a Virtual Host Bus Adapter (VHBA), which is a software component that executes on each node in the cluster, that provides a shared storage topology that, from the perspective of the nodes, is equivalent to the use of SANs as described above. The VHBA provides this shared storage topology by expanding the type of storage devices that can be used in a cluster for shared storage. For example, the VHBA allows the use of storage devices that are directly attached to a node of the cluster to be used as shared storage. In particular, by installing a VHBA on each node, each node in the cluster will be able to use disks that are shared as described above, as well as disks that are not on a shared bus such as the internal drives of a node. Moreover, this invention allows inexpensive drives such as SATA, and SAS drives to be used by the cluster as shared storage.

In one embodiment, a VHBA on each computer system in the cluster creates a storage namespace on each computer system that includes storage devices that are physically connected to the node and devices that are physically connected to other nodes in the cluster. The VHBA on each computer system queries the VHBA on each of the other computer systems in the cluster. The query requests the enumeration of each storage device that is physically connected to the computer system on which the VHBA is located.

The VHBA on each computer system receives a response from each of the other VHBAs. Each response enumerates each storage device that is physically connected to the corresponding computer system. The VHBA on each computer system creates a named virtual disk for each storage device enumerated locally or through other nodes. Each named virtual disk comprises a representation of the corresponding storage device that makes the storage device appear as if disk is locally connected to the corresponding computer system.

The storage namespace comprises named virtual disks where disk ordinal/address is identical across cluster nodes for a given disk/storage.

The VHBA on each computer system exposes each named virtual disk to the operating system on the corresponding computer system. Accordingly, each computer system sees each storage device in the local storage namespace as a physically connected storage device even when disk is not physically connected to the computer system. Clustering ensures that the local storage namespace is identical across cluster nodes

In another embodiment, a policy engine on a computer system implements a high availability policy to ensure that data stored on storage devices in the storage namespace remains highly available to each computer system in the cluster. The policy engine accesses topology information via the storage namespace. The storage namespace comprises a plurality of storage devices. Some storage devices are only connected to a subset of the computer systems in the cluster, and other storage devices are only connected to a different subset of the computer systems in the cluster.

The policy engine implements user defined or built-in policies such that data is protected though redundant array of independent disks (RAID) technology and/or redundant/reliable array of inexpensive/independent nodes (RAIN). Policy engine will ensure no two columns for a given fault-tolerant logical unit (LU) are allocated from disks on a given node, this will ensure that a node failure does not bring down the dependent LU (Logical Unit). Type of RAID employed determines the number of disk failures that LU can tolerate. For example 2-way mirror LU can sustain single column failure as data can be satisfied from the second copy.

The policy engine also determines, from the accessed topology information that in case of DAS (Direct access storage) at least one other storage device connected to other node is used to build RAID based LU such that node loss does not affect availability of the LU.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a typical prior art cluster architecture where each node is directly connected to shared storage;

FIG. 2A illustrates an example computer architecture in which the shared storage techniques of the present invention can be implemented;

FIG. 2B illustrates how a storage device that is not physically connected can be made to appear as a physically connected storage device;

FIG. 2C illustrates how mirroring can be implemented in the example computer architecture;

FIG. 3 illustrates a virtual host bus adapter (VHBA) and virtual disk target in the example computer architecture;

FIG. 4 illustrates how a request flows from an interconnect to VDT and then to a local HBA that has storage connectivity in the example computer architecture;

FIG. 5 illustrates the presence of shared storage devices and remote storage devices in the example computer architecture;

FIG. 6 illustrates a flowchart of an example method for creating a storage namespace that includes storage devices that are physically connected to one or more other computer systems;

FIG. 7 illustrates a read component for creating mirrors within the example computer architecture;

FIG. 8 illustrates a policy engine for enforcing a policy within the example computer architecture; and

FIG. 9 illustrates a flowchart of an example method for implementing a policy for mirroring the content of a storage device on another storage device in a storage namespace.

### DETAILED DESCRIPTION

The present invention extends to methods, systems, and computer program products for minimizing the cost of establishing a cluster of nodes that utilize shared storage. The invention enables storage devices that are physically connected to a subset of the nodes in the cluster to be accessed as shared storage from any node in the cluster.

The invention provides a Virtual Host Bus Adapter (VHBA), which is a software component that executes on each node in the cluster, that provides a shared storage topology that, from the perspective of the nodes, is equivalent to the use of SANs as described above. The VHBA provides this shared storage topology by expanding the type of storage devices that can be used in a cluster for shared storage. For example, the VHBA allows the use of storage devices that are directly attached to a node of the cluster to be used as shared storage. In particular, by installing a VHBA on each node, each node in the cluster will be able to use disks that are shared as described above, as well as disks that are not on a shared bus such as the internal drives of a node. Moreover, this invention allows inexpensive drives such as SATA, and SAS drives to be used by the cluster as shared storage.

In one embodiment, a VHBA on each computer system in the cluster creates a storage namespace on each computer system that includes storage devices that are physically connected to the node and devices that are physically connected to other nodes in the cluster. The VHBA on each computer system queries the VHBA on each of the other computer systems in the cluster. The query requests the enumeration of each storage device that is physically connected to the computer system on which the VHBA is located.

The VHBA on each computer system receives a response from each of the other VHBAs. Each response enumerates each storage device that is physically connected to the corresponding computer system. The VHBA on each computer system creates a named virtual disk for each storage device enumerated locally or through other nodes. Each named virtual disk comprises a representation of the corresponding storage device that makes the storage device appear as if disk is locally connected to the corresponding computer system.

The storage namespace comprises named virtual disks where disk ordinal/address is identical across cluster nodes for a given disk/storage.

The VHBA on each computer system exposes each named virtual disk to the operating system on the corresponding computer system. Accordingly, each computer system sees each storage device in the local storage namespace as a physically connected storage device even when disk is not physically connected to the computer system. Clustering ensures that the local storage namespace is identical across cluster nodes

In another embodiment, a policy engine on a computer system implements a high availability policy to ensure that data stored on storage devices in the storage namespace remains highly available to each computer system in the cluster. The policy engine accesses topology information via the storage namespace. The storage namespace comprises a plurality of storage devices. Some storage devices are only connected to a subset of the computer systems in the cluster, and other storage devices are only connected to a different subset of the computer systems in the cluster.

The policy engine implements user defined or built-in policies such that data is protected though redundant array of independent disks (RAID) technology and/or redundant/reliable array of inexpensive/independent nodes (RAIN). Policy engine will ensure no two columns for a given fault-tolerant logical unit (LU) are allocated from disks on a given node, this will ensure that a node failure does not bring down the dependent LU (Logical Unit). Type of RAID employed determines the number of disk failures that LU can tolerate. For example 2-way mirror LU can sustain single column failure as data can be satisfied from the second copy.

The policy engine also determines, from the accessed topology information that in case of DAS (Direct access storage) at least one other storage device connected to other node is used to build RAID based LU such that node loss does not affect availability of the LU.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

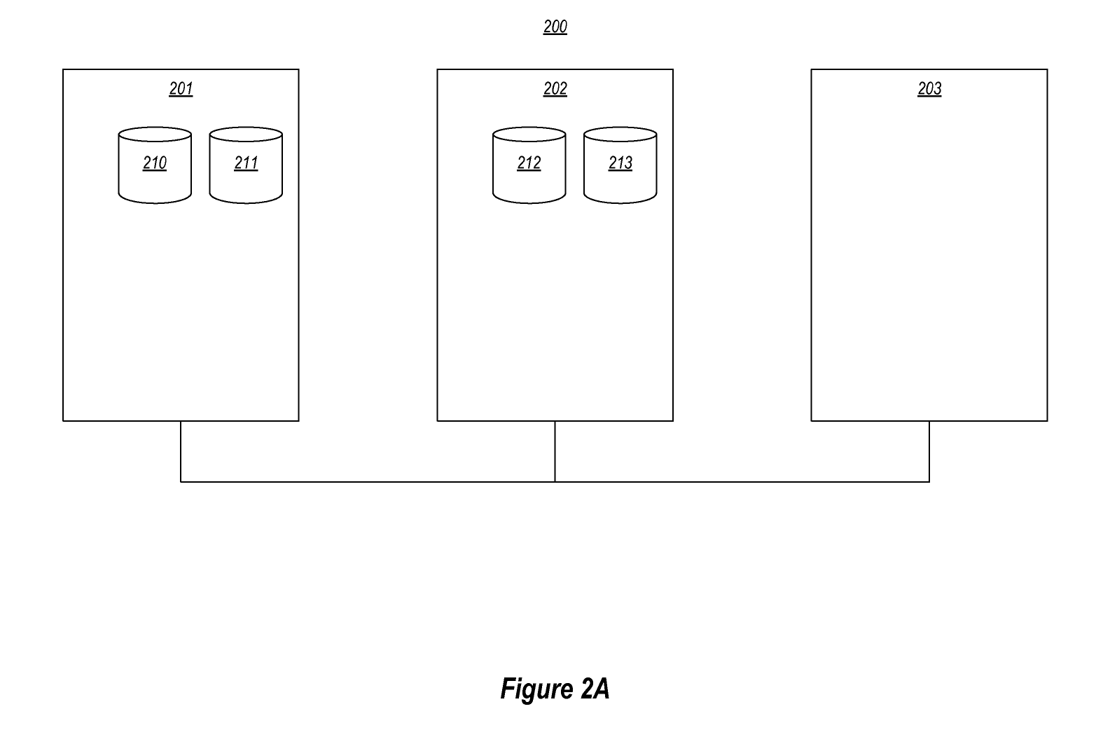

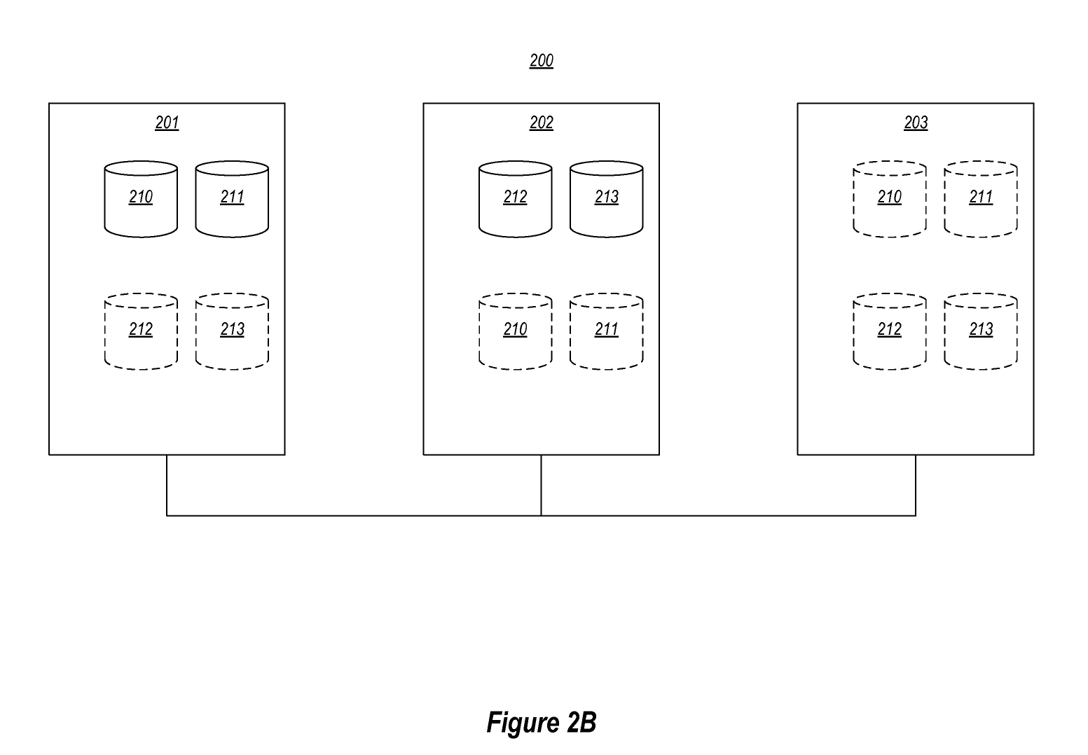

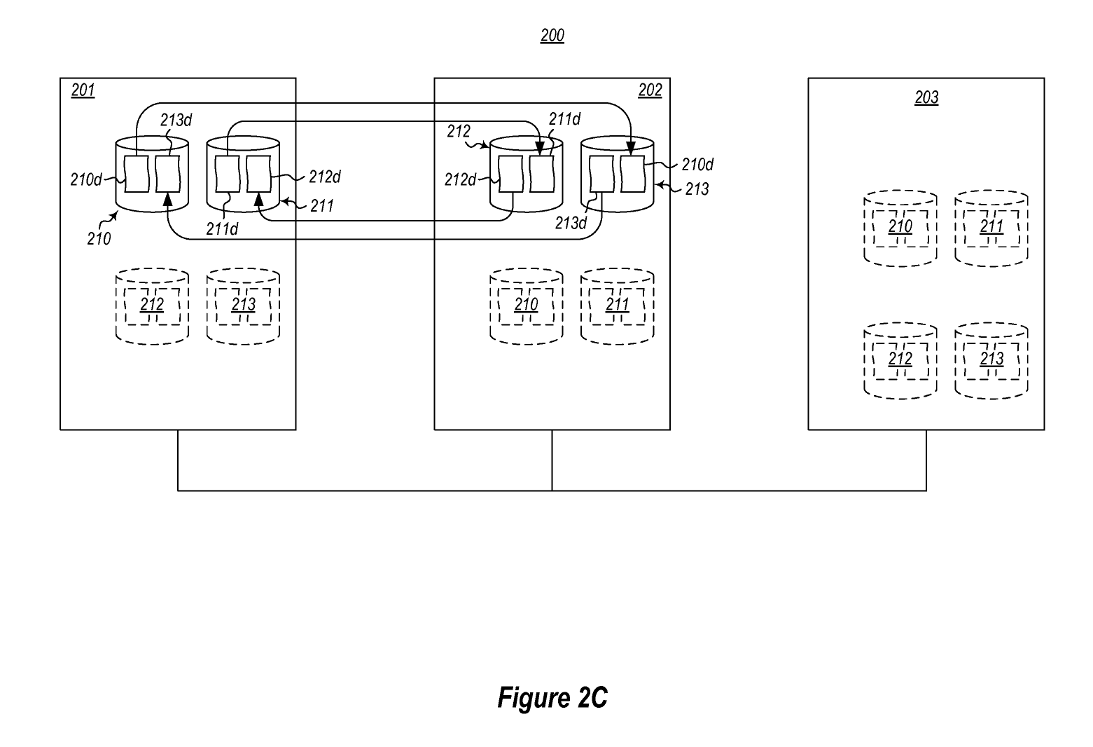

FIG. 2A illustrates an example computer architecture 200 in which the shared storage techniques of the present invention can be implemented. Referring to FIG. 2A, computer architecture 200 includes three nodes (or servers), node 201, node 202, and node 203.

Each of the depicted nodes is connected to one another over (or is part of) a network, such as, for example, a Local Area Network (“LAN”), a Wide Area Network (“WAN”), and even the Internet. Accordingly, each of the depicted nodes as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Each of nodes 201 and 202 is shown as including two local storage devices (210-211, and 212-213 respectively), although a node could include any number of local storage devices, while node 203 is shown as not including any local storage devices. These storage devices can be any type of local storage device. For example, a typical server can include one or more solid state drives or hard drives.

A local storage device is intended to mean a storage device that is local to the node (i.e. physically connected to the node) whether the device is included within the server housing or is external to the server housing (e.g. an external hard drive). In other words, a local storage device includes such drives as the hard drive included within a typical laptop or desktop computer, an external hard drive connected via USB to a computer, or other drives that are not accessed over a network.

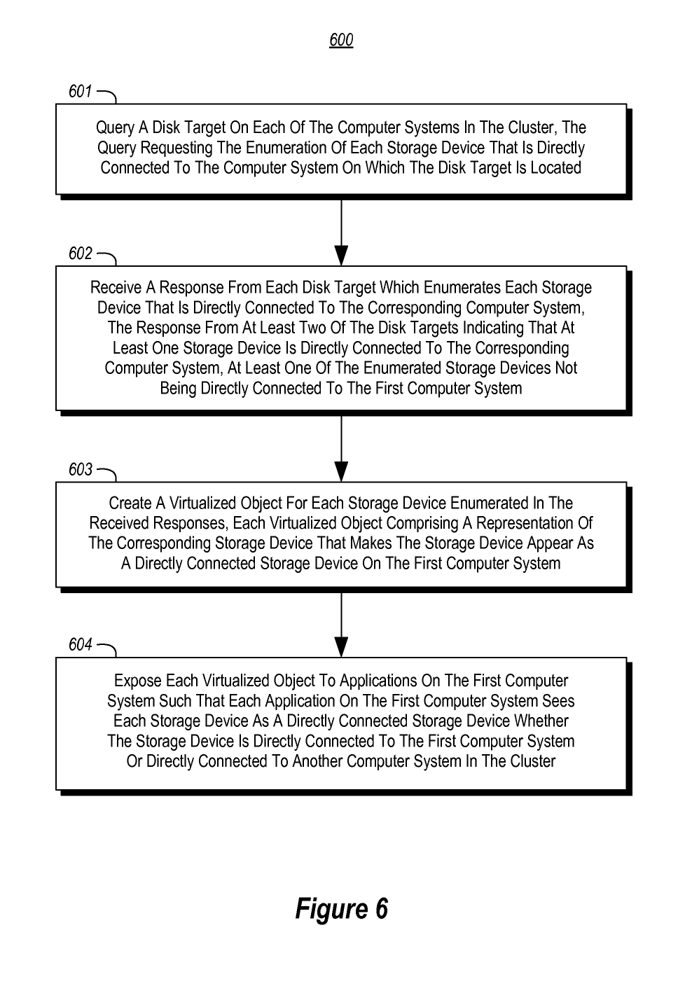

Although the example in FIG. 2A uses local storage devices for simplicity, as described below with respect to FIG. 6, the shared storage techniques of the present invention apply to any storage device that is physically connected to one node, but not from at least one other node in the cluster. This includes remote storage arrays that are only physically connected to a subset (e.g. one) of the nodes in the cluster, as well as storage devices that are shared between some of the nodes (e.g. a shared array).

Regardless of the type of storage device (including both remote and local storage devices), a computer system communicates with the storage device using what will be referred to in this specification as a host bus adapter (HBA). The HBA is the component (usually hardware) at the lowest layer of the storage stack that interfaces with the storage device. The HBA implements the protocols for communicating over a bus which connects the computer system to the storage device. A different HBA can be used for each different type of bus used to connect a computer system to a storage device. For example, a SAS or SATA HBA can be used for communicating with a hard drive. Similarly, a fibre channel HBA can be used to communicate with a remote storage device connected over fibre channel. Additionally, an Ethernet adapter or iSCSI adapter can be used to communicate over a network to a remote computer system. Accordingly, HBA is intended to include any adapter for communicating over a local (storage) bus, network bus or between nodes.

The present invention enables each of the local storage devices in nodes 201 and 202 to be visible as shared storage at any of the other nodes in computer architecture 200. This is illustrated in FIG. 2B. Each node in FIG. 2B is shown as including the local storage devices (in dashes) from the other nodes to represent that these other local storage devices are accessible as shared storage to the node. For example, node 203 is shown as having access to local storage devices 210, 211 on node 201 as well as local storage devices 212, 213 on node 202. Storage devices are shown in dashes to indicate that the storage device appears as being physically connected to the node (i.e. to the layers of the storage stack above the VHBA (e.g. the applications)) even though the storage device is not physically connected to that node. A storage device could be physically connected, for example, over Small Computer System Interface (SCSI), Serial Attached SCSI (SAS), Serial AT attachement (SATA), Fibre Channel (FC), internet SCSI (iSCSI), etc. In these examples, FC and iSCSI storage are not local, rather, they are connected through switches etc. Thus, storage that is physically connected to a node, as used herein, is storage that is masked to the node. This could be directly attached storage and/or disks on storage networks masked to a particular computer node. The physically connected storage is exposed to other nodes through mechanisms such as those described herein.

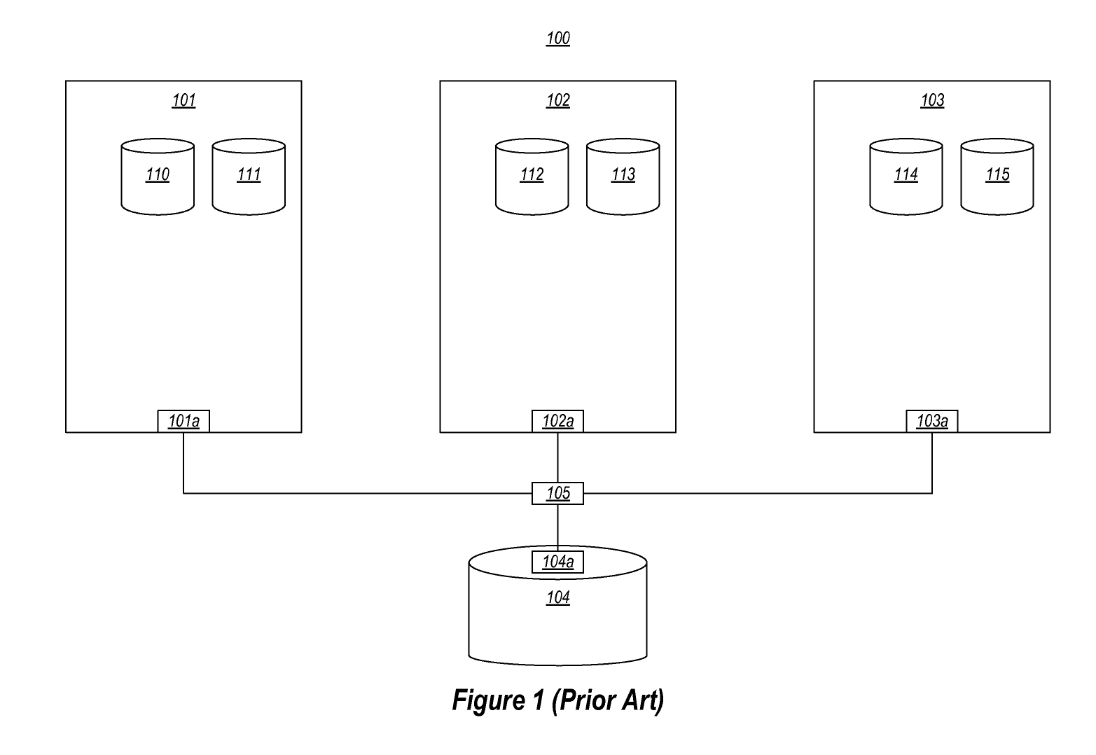

In this way, shared storage can be implemented using the existing local or otherwise physically connected storage devices within the nodes without having to use a separate shared storage (such as shared storage 104 in FIG. 1). By using the local storage devices of each node to implement shared storage, the cost of implementing a cluster can be greatly reduced.

Embodiments of the invention can also compensate for node failure. For example, if node 201 were to go down, storage devices 210 and 211 would also go down (because they are part of node 201). As a result, the virtualized storage devices 210, 211 on nodes 202 and 203 would no longer be available (because nodes 202 and 203 could not physically access storage devices 210, 211 on node 201). Thus, an application running on node 201 and accessing data stored on device 210 or 211 would not be able to failover to node 202 or 203 because the data stored on device 210 or 211 would remain inaccessible from nodes 202 and 203.

RAID technology can be used to absorb disk failures, for example mirroring, or other types of RAID arrays, can be used to compensate for these and other similar occurrences. FIG. 2C illustrates how mirroring can be implemented to ensure that the data on a local storage device does not become inaccessible when the host node goes down. As shown in FIG. 2C, at least some of the data stored on local storage devices 210 and 211 is mirrored (i.e. copied) to one or more of local storage devices 212 and 213 (shown as data 210d from device 210 being copied to device 213, and data 211d from device 211 being copied to device 212). Similarly, at least some of the data stored on local storage devices 212 and 213 is mirrored to one or more of local storage devices 210 and 211 (shown as data 212d from device 212 being copied to device 211, and data 213d from device 213 being copied to device 210). In this way, if either of nodes 201 or 202 goes down, the data stored on the local storage devices of the failed node will still be accessible at each node in the cluster because the data is mirrored on another node.

For example, if node 201 were to go down, an application executing on node 201 and accessing data on device 210 could failover to node 203 and continue accessing the same data by accessing the data that has been mirrored on device 213 on node 202. It is noted that data can be mirrored on more than one node. For example, if node 203 also included a local storage device, the data on any of devices 210-213 could be mirrored on the storage device of node 203. In this example, it is also noted that if node 203 were to include a local storage device, the local storage device could also be virtualized (i.e. made available as shared storage) on nodes 201 and 202 in the manner described above. In other words, local storage devices from multiple nodes can be virtualized on any given node.

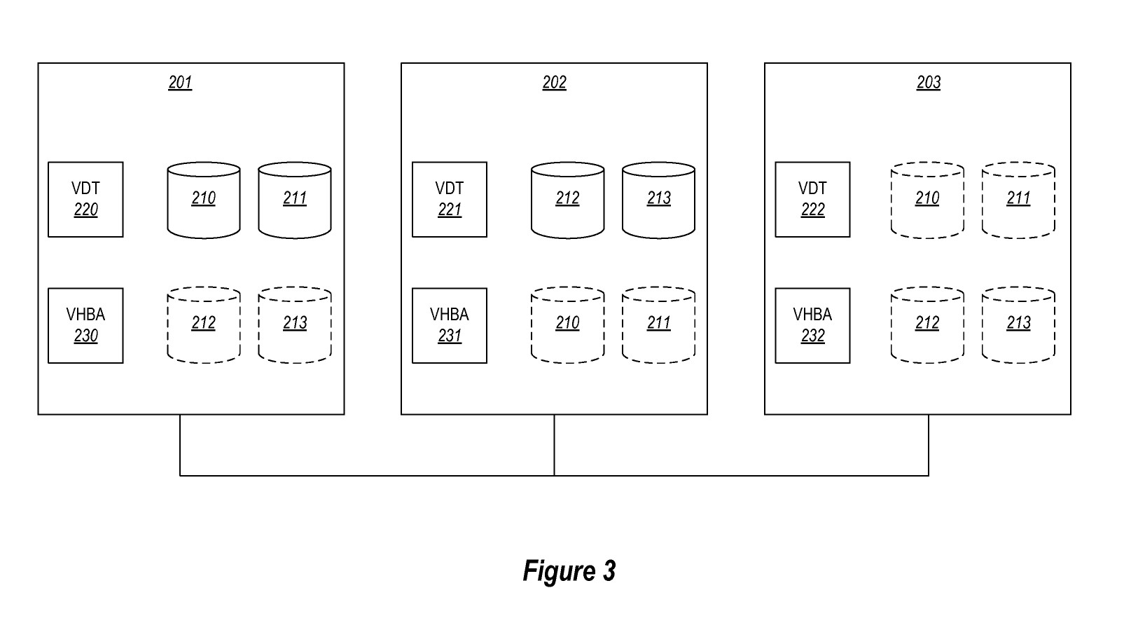

FIG. 3 illustrates a more detailed view of computer architecture 200 representing a particular implementation for virtualizing local storage devices of one node on other nodes of a cluster as shared storage. FIG. 3 is similar to FIG. 2B with the inclusion of a virtual disk target (VDT) 220-222 and a virtual host bus adapter (VHBA) 230-232 on each node respectively.

A virtual disk target is a component of a node (generally of the operating system that is capable of enumerating the local storage devices that are present on the node (or any storage device to which the node has direct access). For example, DT 220 on node 201 is capable of enumerating that local storage devices 210 and 211 are present on node 201. In a cluster, each node is made aware (by the clustering service) of the other nodes in the cluster including the DT on each of the other nodes. Each DT also acts as an endpoint for receiving communications from remote nodes as will be further described below.

A VHBA is a virtualization at the same layer of the storage stack as the HBAs. The VHBA abstracts, from the higher levels of the storage stack (e.g. the applications), the specific topology of the storage devices made available on the node. As described in more detail below, the VHBA acts as an intermediary between the HBAs on a node and the higher layers of the storage stack to provide the illusion that each node sees an identical set of disks in its local storage namespace as if nodes are connected to a shared storage. Local storage namespace will be populated with disks that physically connected to the node and disks that are physically connected to other nodes in the cluster. In some embodiments, each node builds storage namespace based on storage discovery. All participating cluster nodes enumerate same set of storage devices and their address to be identical as well. As a result namespace is identical on each of the cluster nodes

The VHBA on a node is configured to communicate with the DT on each node (including the node on which the VBHA is located) to determine what local storage devices are available on the nodes. For example, VHBA 230 queries DT 220, DT 221, and DT 222 for a list of the local storage devices on nodes 201, 202, and 203 respectively. In response, DT will inform VHBA 230 that storage devices 210 and 211 are local to node 201; DT 221 will inform VHBA 230 that storage devices 212 and 213 are local to node 202; while DT 222 will inform VHBA 230 that no storage devices are local to node 203.

The information obtained by the VHBA from querying a DT on a node also includes properties of each storage device. For example, when queried by VHBA 230, DT 221 can inform VHBA 230 of the properties of storage device 212 such as the device type, the manufacturer, and other properties that would be available on node 202.

Once the VHBA of a node has determined which storage devices are local to each node of the cluster, the VHBA creates a virtualized object to represent each storage device identified as being local to the node. The virtualized object can include the properties of the corresponding storage device. For example, in FIG. 3, VHBA 232 would create four virtualized objects, one for each of storage devices 210-213. These virtualized objects will be surfaced to the applications executing on node 203 in a way that makes storage devices 210-213 appear as if they were local storage devices on node 203. In other words, an application on node 203 generally will not be able to distinguish between storage devices that are local to node 203 (none in this example) and those which are local to another node (storage devices 210-213).

Using another example, on node 201, VHBA 230 surfaces virtualized objects representing storage devices 210 and 211 (which are local storage devices) as well as storage devices 212 and 213 (which are not local storage devices). From the perspective of applications on node 201, storage devices 212 and 213 are accessed in the same manner as storage devices 210 and 211. Through this process, each of nodes 201-203 will see the identical storage namespace (i.e. storage devices 210-213) as a shared storage for the cluster.

To implement the illusion that storage devices of other nodes are local to a node, the VHBA abstracts the handling of I/O requests. Referring again to FIG. 3, if an application on node 201 were to request I/O to storage device 210 (a local storage device), the I/O request would be routed to VHBA 230. VHBA 230 would then route the I/O request to the appropriate HBA on node 201 (e.g. to a SAS HBA if storage device 210 were a hard disk connected via a SAS bus).

Similarly, if an application on node 201 were to request I/O to storage device 212, the I/O request would also be routed to VHBA 230. Because VHBA 230 is aware of the actual location of storage device 212, VHBA 230 can route the I/O request to DT 221 on node 202 which redirects the request to VHBA 231. VHBA 231 will then route the I/O request to the appropriate HBA on node 202 (e.g. to a SAS HBA if storage device 212 were connected to node 202 via a SAS bus).

Any time a VHBA receives an I/O request to access a remote storage device, the I/O request is routed to the DT on the remote node. The DT on the remote node will then redirect the request to the VHBA on the remote node. Accordingly, the DT functions as the endpoint for receiving communications from remote nodes whether the communications are requesting enumeration of local storage devices, or I/O requests to the local storage devices.

Once an I/O request is processed, any data to be returned to the requesting application can be returned over a similar path. For example, the VHBA on the node hosting the accessed local storage device will route the data to the appropriate location (e.g. up the storage stack on the node if the requesting application is on the same node, or to the DT on another node if the requesting application is on the other node).

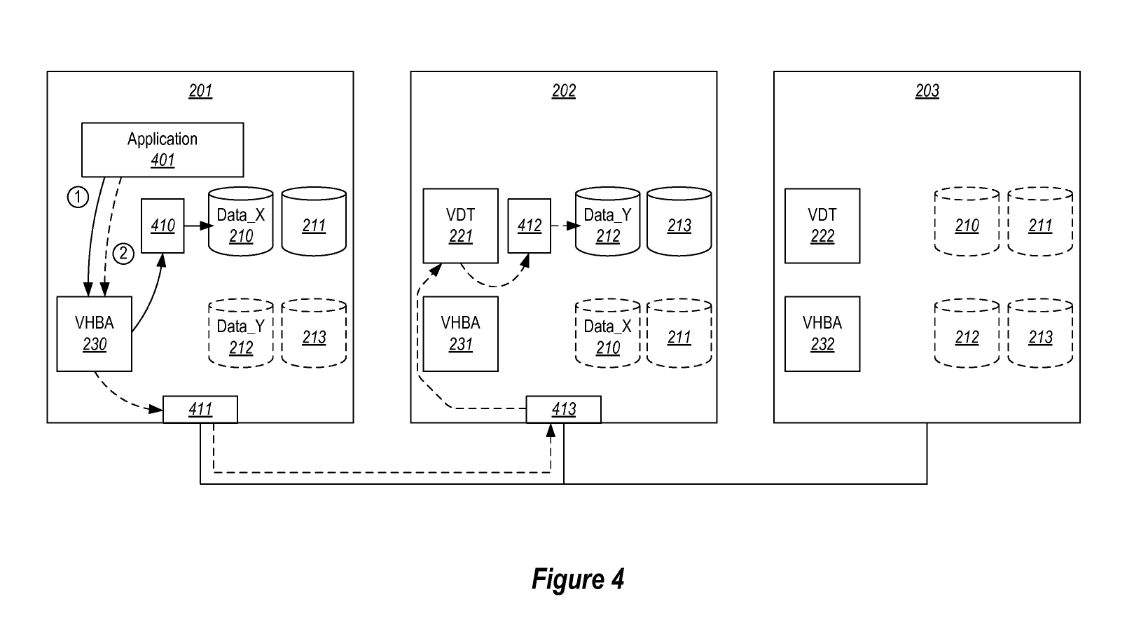

FIG. 4 illustrates how a VHBA routes I/O requests. FIG. 4 is similar to FIG. 3. Node 201 includes HBA 410, which is the HBA for communicating with storage device 210, and interconnect 411, which is the interconnect for communicating over the connection between node 201 and node 202. Similarly, node 202 includes HBA 412, which is the HBA for communicating with storage device 212, and interconnect 413, which is the interconnect for communicating over the connection between node 202 and node 201.

Node 201 includes application 401 which makes two I/O requests. The first request, labeled as (1) and drawn with a solid line, is a request for Data_X that is stored on storage device 210. The second request, labeled as (2) and drawn with a dashed line, is a request for Data_Y that is stored on storage device 212.

From the perspective of application 401, storage devices 210-213 all appear to be local storage devices that are part of the identical storage namespace seen on each node in the cluster (e.g. applications on each node see storage devices 210-213 as physically connected storage devices). As such, application 401 makes requests (1) and (2) in the same manner by sending the requests down the storage stack to VHBA 230. It is noted that application 401 makes these requests as if they were being sent to the actual HBA for the storage device as would be done in a typical computer system that did not implement the techniques of the present invention.

VHBA 230 receives each of requests (1) and (2) and routes them appropriately. Because VHBA 230 is aware of the physical location of each storage device (because of having queried each DT in the cluster), VHBA 230 knows that request (1) can be routed directly to HBA 410 on node 201 to access storage device 210. VHBA 230 also knows that request (2) must be routed to node 202 where storage device 212 is located. Accordingly, even though to application 401, it appears that Data_Y is stored on a physically connected storage device (virtualized storage device 212 shown in dashes on node 201), VHBA 230 knows that Data_Y is physically stored on physical storage device 212 on node 202.

Accordingly, VHBA 230 routes request (2) to interconnect 411 for communication to HBA 412 on node 202. HBA 412 routes the request to DT 221 which redirects it to VHBA 231. VHBA 231 then routes the request to HBA 412 to access storage device 212.

To this point, the disclosure has provided simple examples where each storage device is local to a single node. However, the invention is not limited to such topologies. In many clusters, a storage device is directly connected to multiple nodes. Also, a storage device may be remote to the node, but still physically connected to the node. The present invention applies equally to such topologies. Specifically, a DT enumerates all storage devices to which the host computer system has direct access.

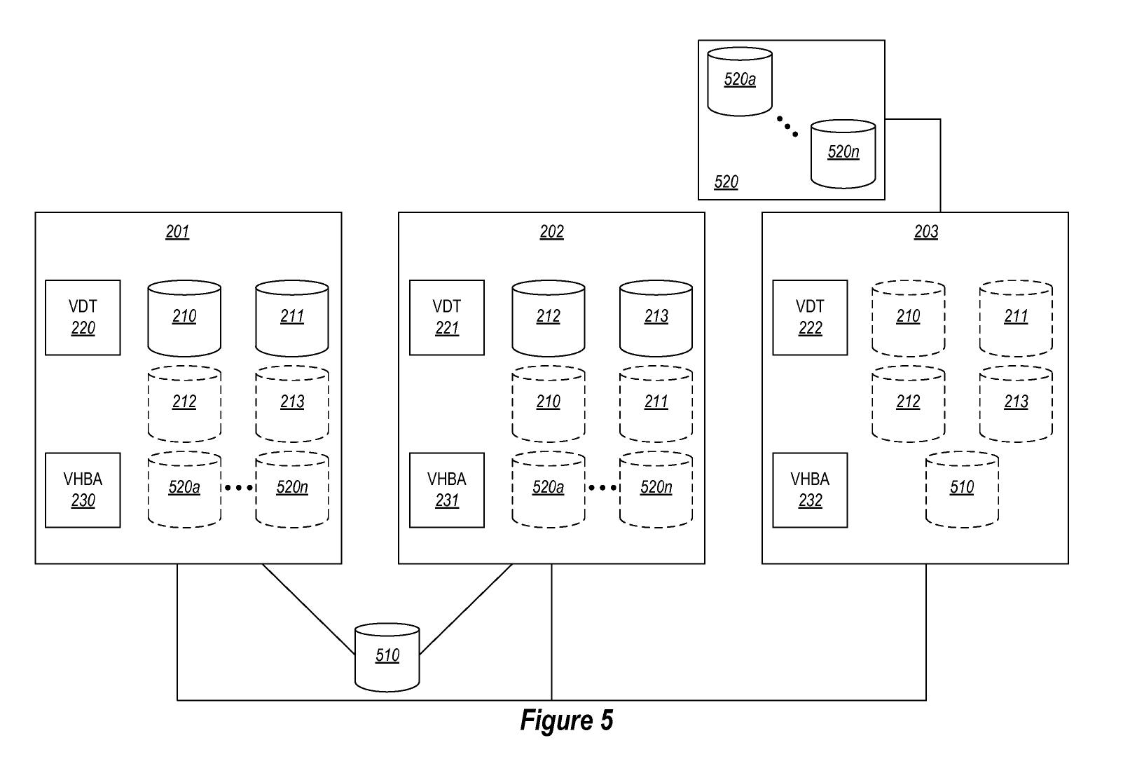

In FIG. 5, computer architecture 200 has been modified to include a storage device 510 that is shared between nodes 201 and 202, and to include a remote storage array 520 that is connected to node 203. The techniques of the present invention can equally be applied in such topologies to create an identical storage namespace across cluster nodes visible at each node that includes storage devices 210-213 as well as storage device 510 and storage devices 520a-520n in storage array 520.

The process for discovering each storage device in the cluster shown in FIG. 5 is performed in the same manner as described above. Specifically, when DT 220 is queried, it will respond that it has direct access to storage devices 210, 211, and 510. Similarly, when DT 221 is queried, it will respond that it has direct access to storage devices 212, 213, and 510. Further, when DT 222 is queried, it will respond that it has direct access to each of storage devices 520a-520n in storage array 520.

One variation that occurs in this example, as opposed to above example involving only local storage devices, is that because two DTs responded that they have direct access to storage device 510, the VHBA will know that there are two paths to reach storage device 510. This information can be leveraged in various ways as addressed below.

As described above, the VHBA on each node will receive the enumeration of physically connected storage devices from each DT and create virtualized objects representing each storage device. Accordingly, the storage namespace visible at each node will include storage devices 210-213, 510, and 520a-520n.

I/O requests to storage devices 520a-520n made by applications on node 201 and 202 will be routed to DT 222 on node 3, redirected to VHBA 231, and then routed to the HBA for communicating with storage array 520. As such, I/O to storage devices 520a-520n is performed in a similar manner as described in the examples above.

In contrast, when an I/O request is made to access data on storage device 510, an additional step may be performed. Because storage device 510 is physically connected to nodes 201 and 202 (i.e. there are two paths to storage device 510), a best path can be selected for routing I/O requests. For example, if VHBA 232 received a request from an application on node 203, it could determine whether to route the request to DT 220 on node 201 or to DT 221 on node 202. This determination can be based on various policy considerations including which connection has greater bandwidth, load balancing, etc.

Additionally, if one available path to a storage device were to fail, I/O requests to the storage device could automatically be routed over the other available paths to the storage device. In this way, the failover to the other path would be transparent to the applications requesting the I/O. In particular, because a VHBA knows of each path to each storage device, the VHBA, independently of the requesting applications of other components at higher layers of the storage stack, can forward I/O requests over an appropriate path to the storage device.

To summarize, any storage device that is physically connected to a node (regardless of the specific details of how the storage device is connected to the node (i.e. whether local or remote)) can be made visible within a storage namespace that is identical across all nodes of a cluster. In this way, all storage devices in the storage namespace will appear as shared storage to applications executing on any of the nodes in the cluster. The VHBA on each node provides the illusion that each storage device in the cluster is physically connected at each node thereby allowing applications to failover to other nodes in the cluster while retaining access to their data. Shared storage is therefore implemented in a way that not every node needs direct access to each storage device. As such, the cost of establishing and maintaining a cluster can be greatly reduced.

FIG. 6 illustrates a flow chart of an example method 600 for creating, on a first computer in a cluster, a storage namespace that includes storage devices that are physically connected to one or more other computer systems in the cluster but not physically connected to the first computer system. Method 600 will be described with respect to the components and data of computer architecture 200 in FIG. 3, although the method can be implemented equally in computer architecture 200 in FIG. 5.

Method 600 includes an act (601) of querying a virtual disk target on each of the computer systems in the cluster. The query requests the enumeration of each storage device that is physically connected to the computer system on which the virtual disk target is located. For example, VHBA 230 can query DTs 220-222 for an enumeration of each storage device that is physically connected to nodes 201-203 respectively.

Method 600 includes an act (602) of receiving a response from each virtual disk target which enumerates each storage device that is physically connected to the corresponding computer system. The response from at least two of the virtual disk targets indicates that at least one storage device is physically connected to the corresponding computer system. At least one of the enumerated storage devices is not physically connected to the first computer system. For example, VHBA 230 can receive a response from DTs 220-222. The response from DT 220 can indicate that storage device 210 and 211 are physically connected to node 201; the response from DT 221 can indicate that storage devices 212 and 213 are physically connected to node 202; and the response from DT 222 can indicate that no storage devices are physically connected to node 203.

Method 600 includes an act (603) of creating a virtualized object for each storage device enumerated in the received responses. Each virtualized object comprises a representation of the corresponding storage device that makes the storage device appear as a physically connected storage device from the first computer system. For example, VHBA 230 can create a virtualized object for each of storage devices 210-213 to make each of storage devices 210-213 appear as if they were all physically connected storage devices on node 201.

Method 600 includes an act (604) of exposing each virtualized object to applications on the first computer system such that each application on the first computer system sees each storage device as a physically connected storage device whether the storage device is physically connected to the first computer system or physically connected to another computer system in the cluster. For example, VHBA 230 can expose the virtualized objects for storage devices 210-213 to applications executing on node 201. These virtualized objects make all of storage devices 210-213 appear as physically connected storage devices on node 201 even though storage devices 212 and 213 are actually on node 202.

Method 600 can equally be implemented on a node such as node 203 where all the storage devices are physically connected to another node in the cluster. In other words, VHBA 232 on node 203 would implement method 600 by creating virtualized objects representing storage devices 210-213 which would make these storage devices appear to applications executing on node 203 as if they were all physically connected storage devices on node 203 even though none of them actually were.

Once method 600 has been implemented on a node to create the storage namespace, applications on the node can perform I/O to any of the storage devices in the namespace as if each storage device were a physically connected storage device. For example, an application on node 201 can read data from storage device 212 in the same manner as it reads data from storage device 210. VHBA 230 creates this abstraction by receiving all I/O requests from applications (i.e. the VHBA resides at the lowest level of the storage stack above the interconnects) whether the request is to a physically connected storage device or not, and routes the request appropriately.

As discussed above, in addition to creating an identical storage namespace on each of the cluster nodes using storage devices local to each node, the present invention also extends to implementing RAID based fault-tolerant devices, for example creating mirrors of the data on the various storage devices in the namespace. Mirroring ensures that the data on a storage device will not become inaccessible when a node (or an individual storage device on a node) goes down.

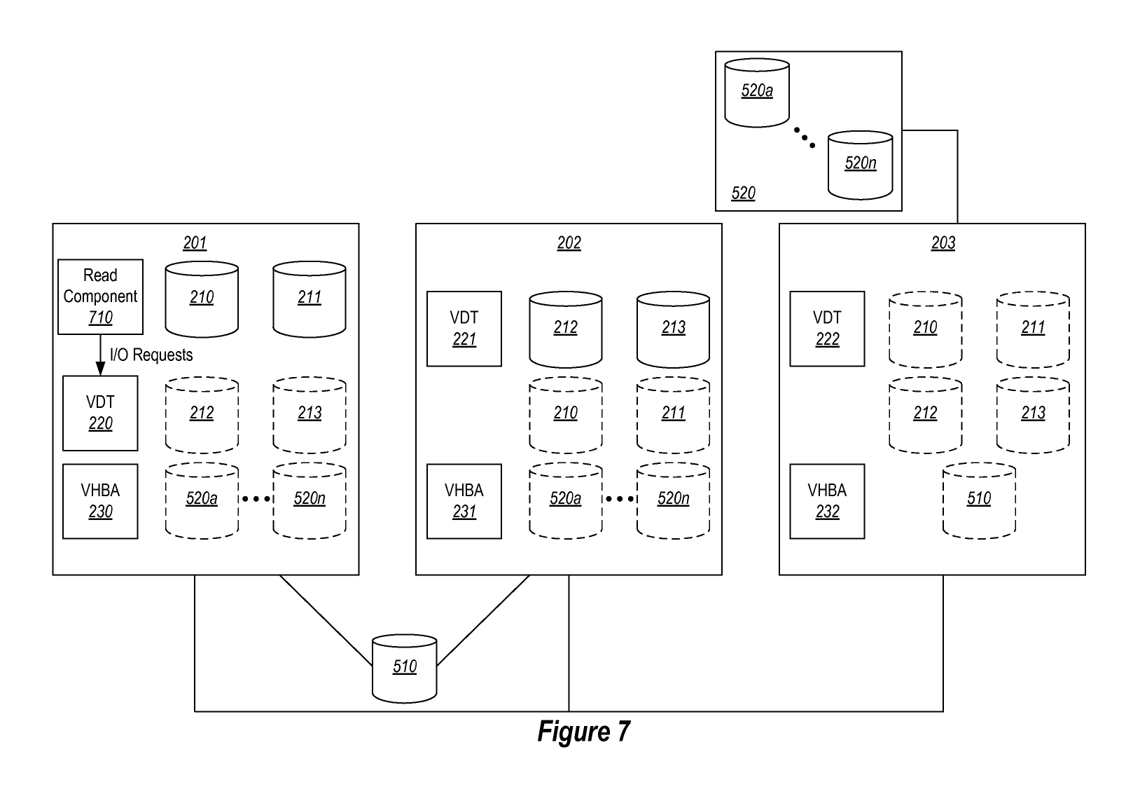

As described above, FIG. 2C provides an example of how data can be mirrored on storage devices of other nodes. As shown in FIG. 7, this mirroring can be implementing using a read component (e.g. read component 710 on node 201) on each node that reads the data of the local storage devices on the node and copies the data to another storage device. This reading and copying can be done at any appropriate time such as when changes are made to the data of the storage device or at a specified interval.

To ensure that a sufficient number of mirrors (to maintain fault-tolerance) are created and that the mirrors are created on appropriate storage devices, a policy engine is used. Similarly for other raid-types policy engine will monitor and maintain fault-tolerant storage state. A policy engine can reside on each node or at least some of the nodes in the cluster (and could be a separate component or could be functionality included within the VHBA). The policy engine ensures that mirroring policies are implemented in the cluster.

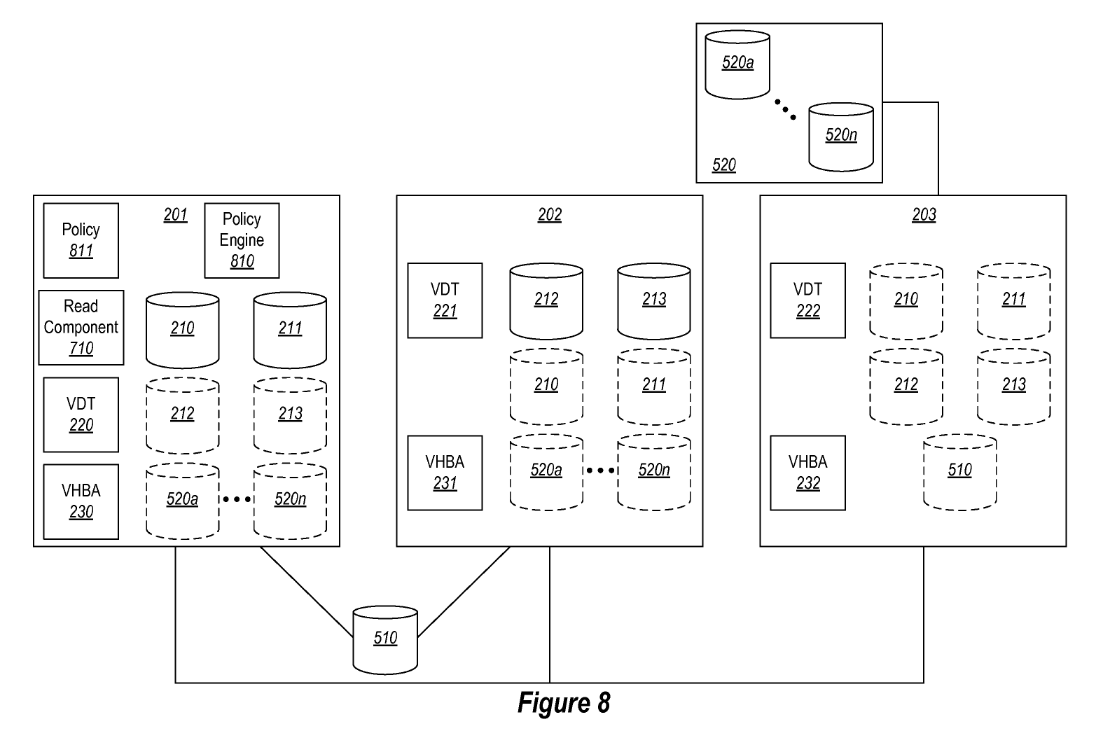

FIG. 8 illustrates computer architecture 200 as shown in FIG. 6 with the addition of policy engine 810 and policy 811 on node 201. For simplicity, a policy engine is not shown on nodes 202 and 203 although each node could include a policy engine. Additionally, although policy 811 is shown in node 201, it could be stored anywhere accessible to policy engine 810 (e.g. in any of the storage devices in the storage namespace).

A mirroring policy can define a number of mirrors that should be maintained for a certain storage device or specified content on a storage device, where the mirrors should be created, how long a node (or storage device) can be down before new mirrors will be created, etc. For example, a policy can define that two mirrors of the content of a storage device should always be maintained (so that three copies of the content exist). If a node that included one of the mirrors were to fail, the policy engine could access the policy to determine that another mirror should be created.

Similarly policies for other raid-type can be defined and implemented.

A primary purpose of the policy engine is to determine where mirrors should be created. Because the storage namespace provides the illusion that all storage devices are physically connected to each node, the policy engine leverages the topology information obtained by querying the DTs to determine where a mirror should be created to comply with an applicable policy. For example, the location of a storage device can be used to ensure that multiple mirrors of the same content are not placed on the same node (e.g. in storage devices 212 and 213) or rack (e.g. within the same rack of storage array 520) so that both mirrors are not lost if that node or rack fails.

Similarly, path information to a particular storage device can be used in this determination. For example, referring to FIG. 8, policy engine 810 can use the path information, obtained by VHBA 230 by querying DTs 220-222, to determine that mirrors of the same content could be placed on storage device 210 and storage device 510. This is because the path information would identify that even if node 201 were to fail, storage device 510 would still be accessible over the path through node 202.

In short, the policy engine uses the information regarding which nodes have direct access to a storage device to determine the placement of mirrors in such a way that a policy is followed. In many clusters, policy dictates that three copies of content exist. Accordingly, the policy engine will ensure that two mirrors of the original content are created and that these mirrors are created on storage devices that are independently accessible (whether they are on different nodes, or accessible via different paths). If a storage device hosting a mirror were to fail, the policy engine can determine whether a new mirror needs to be created (e.g. if the failure is not temporary as defined by the policy), and if so, where to create the mirror to ensure that three copies of the content remain independently accessible.

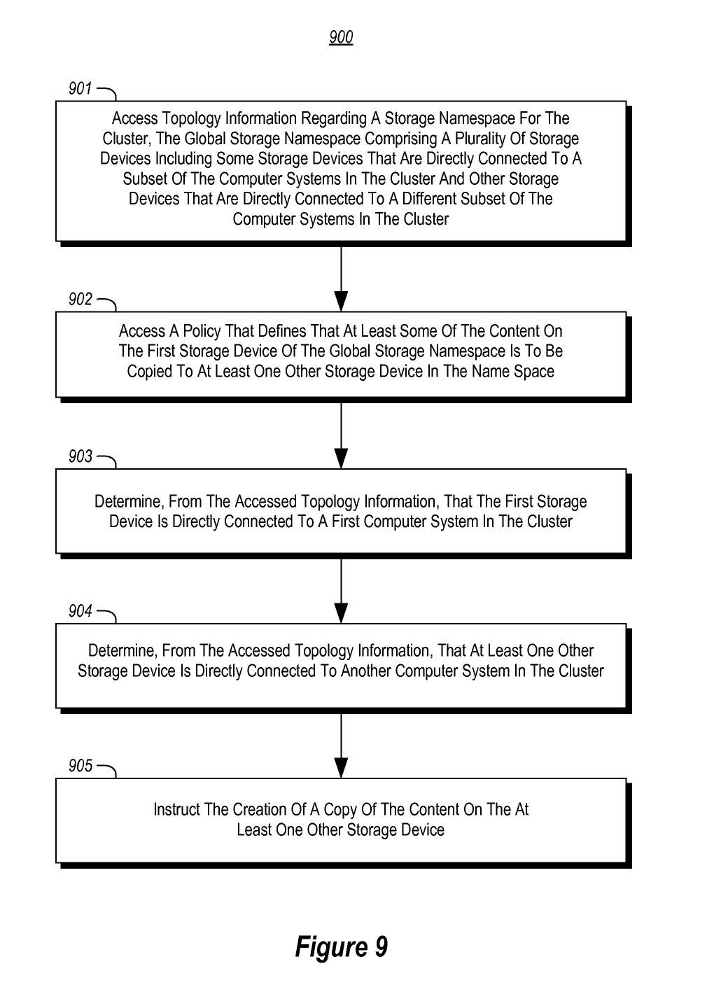

FIG. 9 illustrates a flow chart of an example method 900 for implementing a policy for mirroring the content of a first storage device of a storage namespace on one or more other storage devices in the storage namespace. Method 900 will be described with respect to the components and data of computer architecture 200 shown in FIG. 8.

Method 900 includes an act (901) of accessing topology information regarding a storage namespace for the cluster. The storage namespace comprises a plurality of storage devices including some storage devices that are physically connected to a subset of the computer systems in the cluster and other storage devices that are physically connected to a different subset of the computer systems in the cluster. For example, policy engine 810 can access topology information regarding a storage namespace comprising storage devices 210-213, 510, and 520a-520n.

Method 900 includes an act (902) of accessing a policy that defines that at least some of the content on the first storage device of the storage namespace is to be copied to at least one other storage device in the namespace. For example, policy engine 810 can access policy 811. Policy 811 can specify that content on storage device 210 is to be mirrored on two other storage devices. Instead of mirror the policy engine could deploy other RAID types.

Method 900 includes an act (903) of determining, from the accessed topology information, that the first storage device is physically connected to a first computer system in the cluster. For example, policy engine 811 can determine that storage device 210 is physically connected to node 201 (e.g. from the information obtained by VHBA 230 from DT 222 regarding storage devices that are physically connected to node 201).

Method 900 includes an act (904) of determining, from the accessed topology information, that at least one other storage device is physically connected to another computer system in the cluster. For example, policy engine 810 can determine that storage device 510 is physically connected to node 202 and that storage device 520a in storage array 520 is physically connected to node 203.

Method 900 includes an act (905) of instructing the creation of a copy of the content on the at least one other storage device. For example, policy engine 810 can instruct read component 710 to create a copy of the content from storage device 210 on storage devices 510 and 520a.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a cluster of computer systems where each computer system comprises one or more processors, memory, one or more host bus adapters (HBAs), and a virtual host bus adapter (VHBA), a method, performed by the VHBA on each computer system in the cluster, for creating a storage namespace on each computer system that includes storage devices that are physically connected to the corresponding computer system, as well as storage devices that are connected to each of the other computer systems in the cluster, the method comprising:
the VHBA on each computer system in the cluster querying the VHBA on each of the other computer systems in the cluster, the query requesting the enumeration of each storage device that is physically connected to the computer system on which the queried VHBA is located;
the VHBA on each computer system in the cluster receiving a response from each of the other VHBAs in the cluster, each response enumerating each storage device that is connected to the corresponding computer system, at least one of the responses enumerating a storage device that is not physically connected to the computer system that receives the response;
the VHBA on each computer system in the cluster creating a named virtual disk for each storage device enumerated in the received responses, each named virtual disk comprising a representation of the corresponding storage device that makes the storage device appear as being connected to the corresponding computer system; and
the VHBA on each computer system in the cluster exposing each named virtual disk to the operating system on the corresponding computer system such that each computer system in the cluster sees each storage device in the storage namespace as a physically connected storage device whether the storage device is connected to the corresponding computer system or to another computer system in the cluster.

2. The method of claim 1, wherein the storage namespace comprises a shared storage for applications executing on any computer system in the cluster.

3. The method of claim 1, wherein at least one of the responses enumerates a storage device that is also physically connected to the computer system that receives the response.

4. The method of claim 1, wherein the response from at least one of the VHBAs indicates that no storage devices are physically connected to the corresponding computer system.

5. The method of claim 1, wherein the response from two or more of the VHBAs indicates that a particular storage device is physically connected to each of the two or more corresponding computer systems.

6. The method of claim 5, further comprising maintaining path information regarding each path over which the particular storage device is accessible.

7. The method of claim 1, wherein each named virtual disk includes properties of the corresponding storage device that were included in the response from the corresponding VHBA such that the properties of each storage device are visible to the operating system on each of the computer systems whether or not the storage device is physically connected to the computer system.

8. The method of claim 1, further comprising:
the VHBA on a first computer system in the cluster receiving an I/O request from an application on the first computer system, the I/O request requesting access to data on a first of the storage devices in the storage namespace;
the VHBA on the first computer system selecting one of a plurality of host bus adapters (HBAs) on the first computer system that is to be used to route the I/O request to the first storage device; and
routing the I/O request to the selected HBA.

9. The method of claim 8, wherein the first storage device is connected to the first computer system such that the selected HBA routes the I/O request to the first storage device without routing the I/O request to another VHBA in the cluster.

10. The method of claim 8, wherein the first storage device is connected to the another computer system in the cluster, but not from the first computer system such that the selected HBA routes the I/O request to the VHBA on the other computer system.

11. The method of claim 8, further comprising:
the VHBA on the first computer system determining that the first storage device is connected to a plurality of the other computer systems in the cluster; and
selecting the VHBA from one of the plurality of the other computer systems; and
routing the I/O request to the selected VHBA.

12. The method of claim 11, wherein the VHBA is selected based on a policy.

13. The method of claim 1, further comprising:
Using RAID or other fault-tolerant technique to build fault-tolerant storage using the storages in the namespace, such that virtual storage continues to be available even on disk or node failures. RAID ensures recoverability of data by either making copies on to other storage devices in the namespace or rely on parity to reconstruct missing data (for example-raid-5, raid-6 etc)

14. In a cluster of computer systems where each computer system comprises one or more processors, memory, one or more host bus adapters (HBAs), a virtual host bus adapter (VHBA), and a cluster storage policy engine, a method, performed by the policy engine on each of the computer systems in the cluster, for implementing a high availability policy to ensure that data stored on storage devices in a storage namespace remains highly available to each computer system in the cluster, the method comprising:
accessing topology information regarding a storage namespace for the cluster, the storage namespace comprising a plurality of storage devices including some storage devices that are physically connected to a subset of the computer systems in the cluster and other storage devices that are physically connected to a different subset of the computer systems in the cluster;
accessing a policy that defines that at least some of the content on a first storage device of the storage namespace is to be copied to at least one other storage device in the global namespace;
determining, from the accessed topology information, that the first storage device is physically connected to a first computer system in the cluster;
determining, from the accessed topology information, that at least one other storage device is physically connected to another computer system in the cluster; and
instructing the creation of a copy of the content on the at least one other storage device.

15. The method of claim 14, wherein at least one of the at least one other storage devices is also physically connected to the first computer system.

16. The method of claim 14, wherein at least one of the at least one other storage devices is not physically connected to the first computer system.

17. The method of claim 14, wherein the copy of the content comprises a replica of the content, or an erasure code of the content.

18. The method of claim 14, further comprising:
receiving an indication that a storage device on which the content is stored is no longer accessible;
determining, from the topology information, another storage device on which the content can be copied, the other storage device being selected to ensure that the policy is complied with; and
instructing the creation of a copy of the content on the other storage device to comply with the policy.

19. The method of claim 14, wherein the topology information is obtained from the VHBA on each of the computer systems in the cluster, each VHBA specifying each storage device that is physically connected to the corresponding computer system.

20. One or more computer storage media storing clustering software for creating a storage namespace in a cluster that enables each node in the cluster to access each storage device that physically connected to any of the nodes in the cluster whether or not the storage device is physically connected to the accessing node, the clustering software comprising:
computer executable instructions which, when executed on each node of a cluster, implement a virtual host bus adapter (VHBA) on each node, the VHBA on each node being configured to:
query the VHBA on each of the other nodes in the cluster, the query requesting the enumeration of each storage device that is physically connected to the node on which the queried VHBA is located;
receive a response from each of the other VHBAs in the cluster, each response enumerating each storage device that is physically connected to the corresponding node, at least one of the responses enumerating a storage device that is not physically connected to the node that receives the response;
create a named virtual disk for each storage device enumerated in the received responses, each named virtual disk comprising a representation of the corresponding storage device that makes the storage device appear as being physically connected to the corresponding node;
expose each named virtual disk to the operating system on the corresponding node such that each node in the cluster sees each storage device in the storage namespace as a physically connected storage device whether the storage device is physically connected to the corresponding node or physically connected to another node in the cluster;
receive an I/O request from an application on the corresponding node, the I/O request requesting access to data on a first of the storage devices in the storage namespace;
determine which node the first storage device is physically connected to, the determination being based on the enumerated storage devices in the received responses from each VHBA in the cluster; and
routing the I/O request to the VHBA on the determined node from which the first storage device is physically connected to.
